(19) United States
(12) Patent Application Publication
(10) Pub. No.: US 2008/0034115 A1
(43) Pub. Date: Feb. 7, 2008

(54) Apparatus for handling hash collisions of hash searching and method using the same

(76) Inventors: Yuan-Sun Chu, Ming-Hsiung (TW); Jia-Huang Lin, Ming-Hsiung (TW); Yi-Mao Hsiao, Ming-Hsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/496,548

(22) Filed: Aug. 1, 2006

(51) Int. Cl. G06F 15/173

(52) U.S. Cl. 709/239; 709/238

(57) ABSTRACT

An apparatus for handling hash collision of hash searching includes a hash table unit, a content addressable memory (CAM) and a multiplexer encoder. When the data are hashed to produce a hash index, and hash collision occurs, the data are stored into the CAM. When performing a hash search, the hash table unit and the CAM will be simultaneously looked up and the result will be found in only one period of time.

### BACKGROUND

1. Field of Invention

The present invention relates to an Internet routing technique. More particularly, the present invention relates to a method and an apparatus for searching and updating routing paths of a high speed router.

2. Description of Related Art

For high speed routers, Internet Protocol, IP routing needs to perform longest prefix matching of destination address of each incoming packet so as to obtain an output port of a next hop router. Therefore, route searching mechanism has become a critical issue that significantly restricts the speed of transmitting packets for routers.

A route searching mechanism in accordance with prior art generally uses hash searching method to reduce searching frequencies of routing paths for routers. However, the shortcoming is the hash collision.

Hash collision means that if there are two or more than two keys in hash searching being hashed to the same address (index) in a hash table, the collision occurs. The prior art uses mainly two techniques to resolve the hash collision problem. The first technique is so-called “linear open addressing” while the second technique is so-called “linked list”.

In the first method of linear open addressing, a hash collision is resolved by probing, or searching through alternate locations in the hash table until either the target record is found, or an empty entry is found. The IP address of where hash collision occurs is stored into a closest and empty entry if any empty entry of the hash table is found. When looking up the hash table, the searching is started at the hashed address until any empty entry in the hash table has been found.

However, using linear open addressing may have a problem, “clustering effect”. The clustering effect happens, because there are different IP addresses being hashed into the same address. The clustering effect may bring a serious delay while looking up the table. Although the linear open addressing has the best memory performance, but is most sensitive to clustering. The system delay caused by the clustering needs to be considered.

In the second method of linked list, an additional buffer is added to the system in addition to main memory. Each colliding IP address references a linked list of inserted records that collide in the same address and is stored in the buffer. Linear search is used to look up the table to complete the searching.

If the length of each linked list is n, and the average amount of times of looking up the table will be

$$\frac{n ( n + 1 )}{2} .$$

Therefore, worse case needs to compare n numbers of linked lists to complete looking up the table. For linked list method, there may be lots of the colliding IP addresses, the buffer size is demanded largely, and the searching time is extended because of the large sized buffer. In considerations of designing the system, the buffer size will influence significantly the performance of searching the table. Otherwise, a large buffer size will be needed, but using large buffer will also increase table searching time. For balancing buffer size and table searching time, there is a need to have an improved method and apparatus to resolve the problems.

### SUMMARY

An object of the present invention is to provide a method and an apparatus to handle hash collisions in hash searching for IP address routing and increase improve the performance of IP address routing.

An apparatus in accordance with the present invention includes a hash table unit, a content addressable memory (CAM), a multiplexer and a multiplexer decoder. When a piece of data is hashed and a hash index is generated, and a hash collision occurs, the colliding data is stored in the content addressable memory. The hash table unit and the content addressable memory are simultaneously looked up when a hash searching is performed. If the target data is found in the hash table unit, a first signal is transmitted to the multiplexer encoder. If the target data is found in the content addressable memory, a second signal is transmitted to the multiplexer encoder. The multiplexer encoder has a MUX_Sel pin that controls the outputs of the multiplexer with the first and the second signals.

The method in accordance with the present invention includes,

(a) providing a hash function, a hash table unit and a content addressable memory, wherein each of the hash table and the content addressable memory has multiple entries;

(b) receiving a piece of data, and obtaining a key of the piece of data;

(c) hashing the key with the hash function to generate a hash index corresponding to the key; and

(d) accessing the piece of data with one of the entries of the hash table unit according to the hash index;

wherein, when the hash index collides, the piece of data is stored in one of the entries of the content addressable memory.

The accessing operation in step (d) may be searching, deleting, adding and updating operations.

The present invention uses a small part of content addressable memory to resolve hash collisions. When a hash collision happens, searching simultaneously-the hash table unit and the content addressable memory only takes one period of operation to obtain the result. Therefore, the searching time is shortened. Besides, adding, updating and deleting operations for the hash table only take respectively two periods of operation, one period of operation and one period of operation.

### BRIEF DESCRIPTION OF THE DRAWINGS

These and other features, aspects, and advantages of the present invention will become better understood with regard to the following description, appended claims, and accompanying drawings where:

FIG. 1 is a distribution of longest prefix length generated by a Mac-east software.

FIG. 2 is schematic diagram of a preferred embodiment in accordance with the present invention.

FIG. 3 is schematic diagram of a hash table of a hash table unit in FIG. 2.

FIG. 4 is a pin diagram of the preferred embodiment in accordance with the present invention in FIG. 2.

FIG. 5 is a schematic diagram of data format of the hash table unit and a content addressable memory.

FIG. 6 is a pin diagram of the hash table unit in FIG. 4.

FIG. 7 is a pin diagram of the content addressable memory in FIG. 4.

FIG. 8 is a pin diagram of a multiplexer encoder in FIG. 4.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

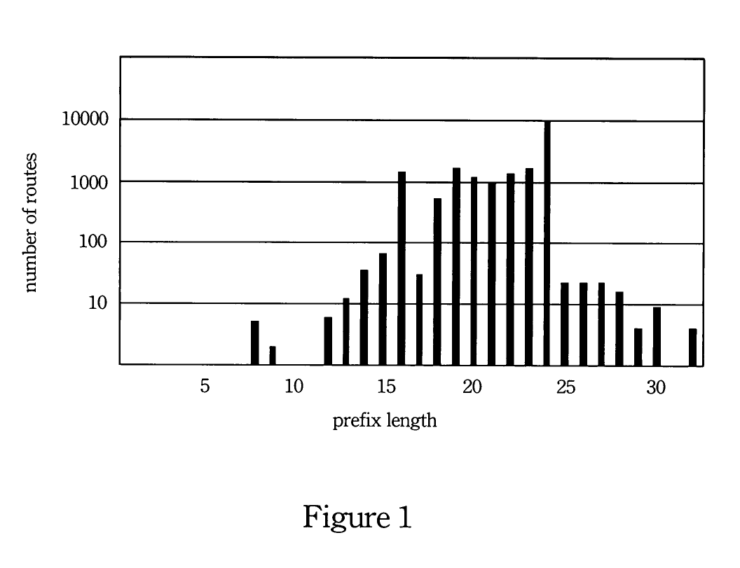

With reference to FIG. 1, FIG. 1 illustrates distribution of longest prefix matching by Mac-east software. FIG. 1 could clearly show that the general prefix bit lengths in the networks are distributed between 16 to 24 bits. Especially, a prefix length with 24 bits is most significant for current class C category for IP address. A prefix length with more than 24 bits is not many. Therefore, if the front 24 bits of a destination address in IP version 4 are obtained, using a hash function to hash the bits will generate a hash index of a hash table. Then, looking up an entry of the hash table corresponding to the hash index will reduce averaged searching time.

The preferred embodiment uses the front 24 bits of a destination address in IP version4 for illustrative purposes only. The front 24 bits are regarded as a key that is input into the hash apparatus. When two keys are hashed to the same address, a hash collision occurs. The colliding data, IP addresses, are stored in a content addressable memory.

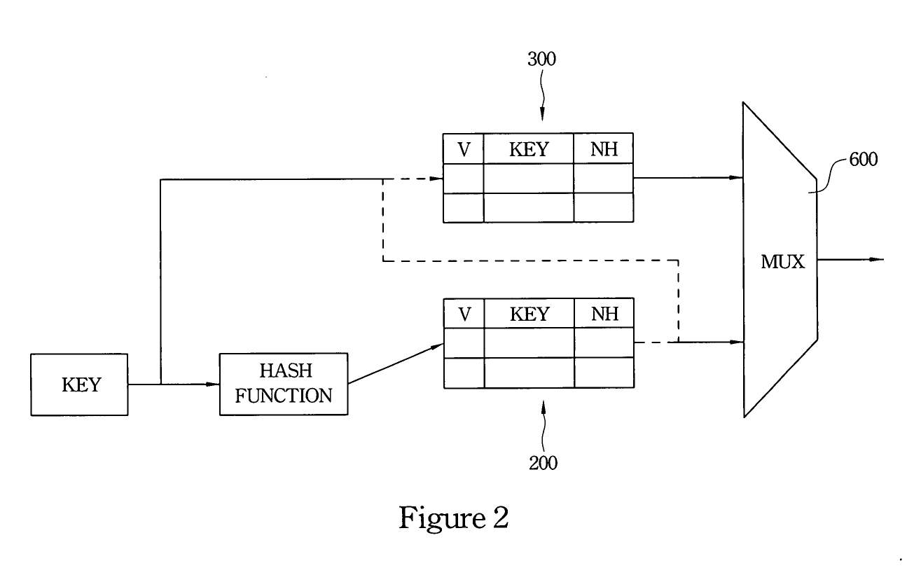

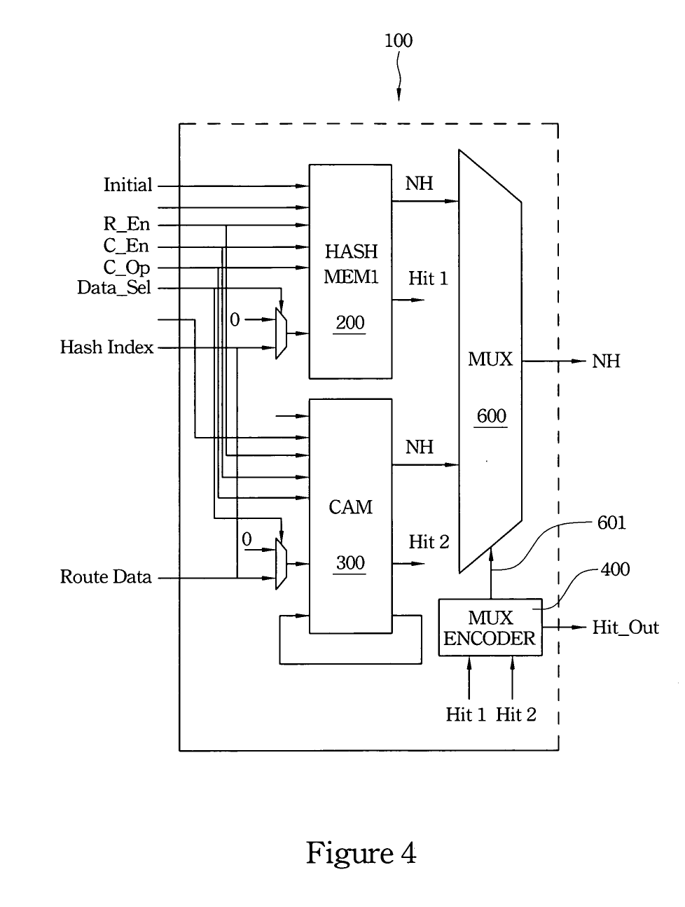

With reference to FIG. 2 and FIG. 4, a hash apparatus 100 in accordance with the present invention comprises a hash table unit 200, a content addressable memory 300, a multiplexer decoder 400 and a multiplexer 600. The hash table unit 200 may be implemented by dynamic random access memory, DRAM.

Since the hash table unit 200 and the content addressable memory 300 are independent to each other, the hash table unit 200 and the content addressable memory 300 could be simultaneously searched and looked up while performing an address path searching. The content addressable memory 300 is a special type of computer memory, and only needs single operation to complete entire memory search. Therefore, it only takes one period of time to complete searching the hash table unit 200 and the content addressable memory 300 to obtain the result.

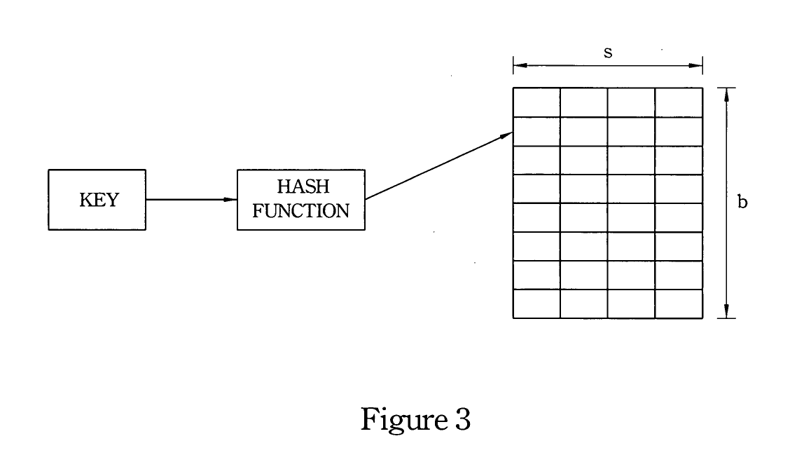

With reference to FIG. 3, a method of estimating the size of the content addressable memory 300 is provided. Based on determining averaged overflow, it is supposed that there are K numbers of keys, b number of buckets, s size of each bucket, and the keys are independent to each other. The probability for a hashed IP address to be corresponded to every bucket is the same. The probability of n number of hashed IP addresses of k numbers of IP addresses are hashed to the same bucket can be,

$$p ( k , n , b ) = {{C}_{n}^{k} ( \frac{1}{b} )}^{n} \times {( 1 - \frac{1}{b} )}^{k - n} \qquad ( 1 )$$

The probability of occurring overflow, Poverflow, can subtract Poverflow from 1 and become,

$$Poverflow = 1 - {{C}_{0}^{k} ( \frac{1}{b} )}^{0} \times {( 1 - \frac{1}{b} )}^{k} + {{C}_{1}^{k} ( \frac{1}{b} )}^{1} \times {( 1 - \frac{1}{b} )}^{k - 1} + … + {{C}_{s}^{k} ( \frac{1}{b} )}^{s} \times {( 1 - \frac{1}{b} )}^{k - s} = 1 - {\sum }_{n = 0}^{s} p ( k , n , b ) \qquad ( 2 )$$

Therefore, an expected valve of storing keys into a bucket, ExpBucket(k,s,b), is

$$ExpBucket ( k , s , b ) = {\sum }_{n = 0}^{s} p ( k , n , b ) \times n + {\sum }_{n = s + 1}^{k} p ( k , n , b ) \times s = {\sum }_{n = 0}^{s} p ( k , n , b ) \times n + [ 1 - {\sum }_{n = 0}^{s} p ( k , n , b ) ] \times s = s + {\sum }_{n = 0}^{s} p ( k , n , b ) \times ( n - s ) \qquad ( 3 )$$

A supposed expected valve of overflow, Expoverflow(k,s,b), is

$$\frac{k - ExpOverflow ( k , s , b )}{b} = ExpBucket ( k , s , b ) \\ \begin{matrix}ExpOverflow ( k , s , b ) = k - b \times ExpBucket ( k , s , b ) \\ = k - b [ s + {\sum }_{n = 0}^{s} p ( k , n , b ) \times ( n - s ) ] \\ = k - b [ s + {\sum }_{n = 0}^{s - 1} p ( k , n , b ) \times ( n - s ) ]\end{matrix} \qquad ( 4 )$$

The appropriate size of the content addressable memory 300 could be estimated by aforesaid formulas for store colliding hash keys.

For example, supposing there are 256 keys, and the hash table has 2⁹ entries. If a hash collision occurs, then the second and later pieces of data reference to the same address are stored in the content addressable memory 300. Therefore, the value of k in the expected value calculation formula is 256. The hash table has an amount of 512 buckets, and each bucket can store a hash entry. The averaged value of overflow is 54. The appropriate size of the content addressable memory 300 can be estimated to be about 54 entries or more than 54 entries.

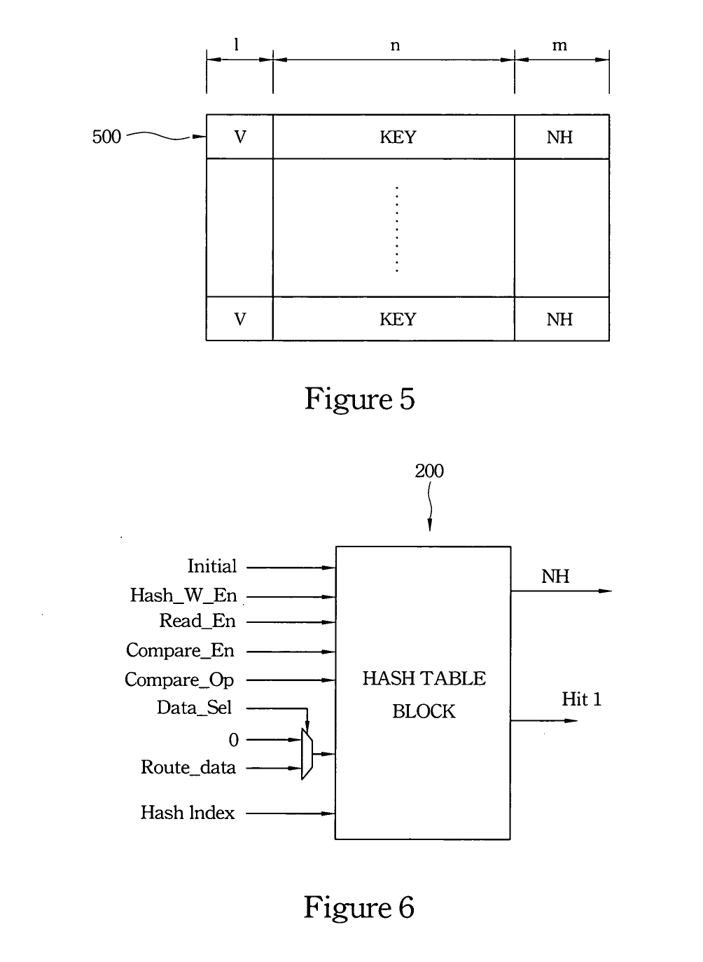

With reference to FIG. 5, which illustrates the data format of the hash table unit 200 and the content addressable memory 300. Each of the hash table unit 200 and the content addressable memory 300 has multiple entries 500.

With further reference to FIG. 6, which illustrates pin diagram of the hash table unit 200. The pins, Hash_W_En, Read_En, Compare_En, Compare_Op and Data_Sel are connected to a control unit, such as a Finite State Machine, FSM controller.

When an operation of search is started, the Compare_En pin is set to 1 and the Compare_Op pin is set to 0. If there are target key found according to a referenced entry by the hash index, the Hit1 pin is set to 1, and the Read_En pin is enabled after a period of operation. Thus, the data in the NH column of the referenced hash entry will be output.

When an operation of adding a new piece of data is started, the Compare_En pin and the Compare_Op pin are set to 1. If the value of the V column is set to 0 (zero) according to a referenced entry by the hash index, the Hit1 pin is set to 1, and the Hash_W_En pin is enabled after a period of operation. The data transmitted through the Route_Data pin can be written into the referenced entry of the hash table.

When an operation of updating an old key is started, the pins, Compare_En=1 and Compare_Op=0. If the valve of the key column of a referenced entry is fitted in with the key valve transmitted through the pin, Route_Data according to the referenced entry by the hash index, the pin Hit1 is set to 1 and the pin Hash_W_En is enabled after a period of operation. The valve of the NH column of the referenced entry is updated.

When an operation of deleting a key is started, the Compare_En pin is set to 1 and the Compare_Op pin is set to zero. If the value of the key column of a referenced entry in matched with the key value transmitted through the Route_Data pin according to the referenced entry by the hash index, the Hit1 pin is set to 1, the Hash_W_En pin is enabled after a period of operation and the Data_Set pin is set to 1. The value of the NH column of the referenced entry is deleted, i.e. writing 0 into the referenced column.

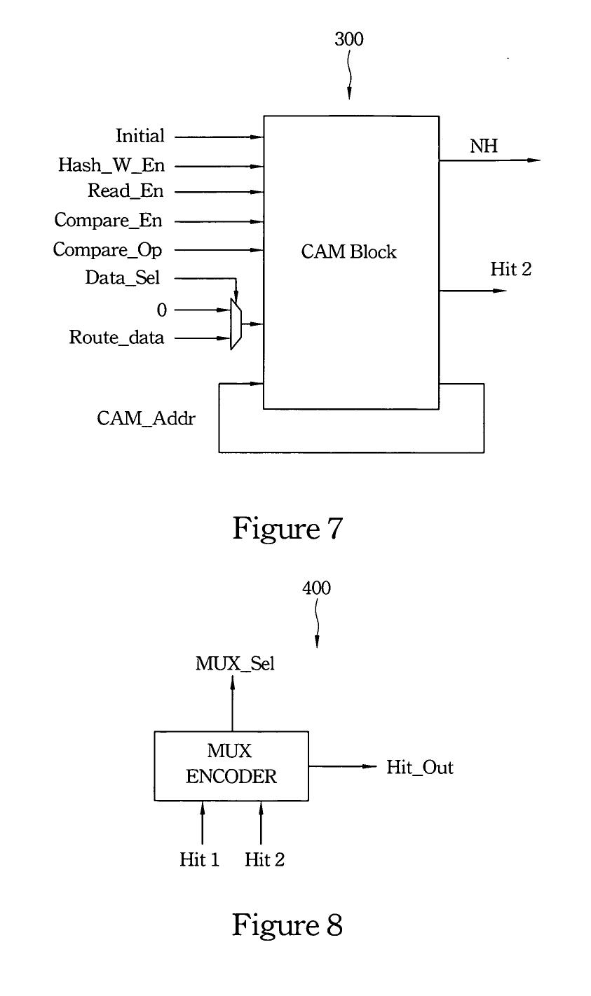

With reference to FIG. 7, if a hash collision occurs, the second and later pieces of colliding data are stored in the content addressable memory 300. The pins of the content addressable memory 300, CAM_W_En, Read_En, Compare_En, Compare_Op and Data_Sel are connected to the same control unit of the hash table unit 200.

When an operation of searching is started, the Compare_En pin is set to 1 and the Compare_Op is set to 0. Each entry of the content addressable memory 300 is simultaneously searched. If the key value of an entry of the content addressable memory 300 in matched with the key value transmitted through the Rout_Data pin, the Hit2 pin is set to 1 and the Pin Read_En is enabled. The data in the referenced entry is transmitted through the pin, CAM_Data.

When an operation of adding a new piece of data is started, the Compare_En pin and the Compare_Op pin are set to 1. Each entry of the content addressable memory 300 is simultaneously searched. If there are more than two entries with their V columns are to 0 (zero), then using one of the entries with lower level address to write. The Hit2 pin is set to 1 and the CAM_W_En pin is enabled after a period of operation. The data transmitted through the Route_Data pin can be written into the referenced entry.

When an operation of updating an old key is started, the Compare_En pin is set to 1 and the Compare_Op pin is set to 0. Each entry of the content addressable memory 300 is simultaneously searched. If there is one entry with its key valve matched with the key value transmitted by the Route_Data pin, The Hit2 pin is set to 1 and the CAM_W_En pin is enabled after a period of operation. The content of the NH column of the referenced entry is updated.

When an operation of deleting a key is started, the Compare_En pin is set to 1 and the Compare_Op is set to 0. Each entry of the content addressable memory 300 is simultaneously searched. If there is one entry with its key value matched with the key value transmitted by the Route_Data pin, The Hit2 pin is set to 1, the CAM_W_En pin is enabled after a period of operation and the Data_Set pin is set to 1. The value of the NH column of the referenced entry is deleted, i.e. writing 0 into the referenced column.

With reference to FIG. 4 and FIG. 8, which illustrates the pin diagram of the multiplexer encoder 400. The multiplexer encoder 400 has an output pin MUX_Sel 601 that is connected to the multiplexer 600 as a selection pin. The hash table unit 200 and the content addressable memory 300 are connected to the multiplexer 600, as well as the Hit1 pin and Hit2 pin are connected to the multiplexer encoder 400. The output of the multiplexer 600 is controlled based on the selection pin, MUX_Sel 601. When the Hit1 pin is equal to 1, which means the data are found in the hash table unit 200, the MUX_Sel pin is set to 0 and the data in the NH column of the referenced entry in the hash table unit 200 is output. When the Hit2 pin is equal to 1, which means the data are found in the content addressable memory 300, the MUX-Sel pin is set to 1 and the data in the NH column of the referenced entry in the content addressable memory 300 is output. Besides, either the Hit1 pin or the Hit2 pin is equal to 1, the Hit_Out pin is set to 1 for outside testing.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for handling hash collisions of hash searching, and the method comprising
(a) providing a hash function, a hash table unit and a content addressable memory, wherein each of the hash table and the content addressable memory has multiple entries;
(b) receiving a piece of data, and obtaining a key of the piece of data;
(c) hashing the key with the hash function to generate a hash index corresponding to the key; and
(d) accessing the piece of data with one of the entries of the hash table unit according to the hash index;
wherein, when the hash index collides, the piece of data is stored in one of the entries of the content addressable memory.

2. The method as claimed in claim 1, wherein step (a) further comprises
determining a size of the content addressable memory based on
$$ExpOverflow ( k , s , b ) = k - b [ s + {\sum }_{n = 0}^{s - 1} p ( k , n , b ) \times ( n - s ) ] ,$$
wherein
$$p ( k , n , b ) = {{C}_{n}^{k} ( \frac{1}{b} )}^{n} \times {( 1 - \frac{1}{b} )}^{k - n} ,$$
k is an amount of the keys, b is an amount of the entries of the hash table unit, and s is an amount of the entries of the hash table unit permitting to store the keys.

3. The method as claimed in claim 1, wherein the data uses Internet protocol address format.

4. The method as claimed in claim 1, wherein the hash table unit uses dynamic random access memory.

5. The method as claimed in claim 1, wherein the method is used by an Internet address router with a hash searching table.

6. The method as claimed in claim 1, wherein the accessing operation in step (d) is a searching operation.

7. The method as claimed in claim 1, wherein the accessing operation in step (d) is a deleting operation.

8. The method as claimed in claim 1, wherein the accessing operation in step (d) is an adding operation.

9. The method as claimed in claim 1, wherein the accessing operation in step (d) is an updating operation.

10. An apparatus for handling hash collisions of hash searching and the apparatus comprising a hash table unit;
a content addressable memory;
a multiplexer connected to the hash table unit and the content addressable memory; and
a multiplexer decoder connected to the multiplexer, the hash table unit and the content addressable memory;
wherein when a piece of data is hashed to generate a hash index, the data is stored in the hash table unit according to the hash index, and when a hash collision occurs, the colliding data is stored in the content addressable memory.

11. The apparatus as claimed in claim 10, wherein the hash table unit is a dynamic random access memory.

12. The apparatus as claimed in claim 10, wherein the hash table unit and the content addressable memory are simultaneously searched when the hash searching is performed.
